(19) United States
(12) Patent Application Publication
(10) Pub. No.: US 2009/0210708 A1
(43) Pub. Date: Aug. 20, 2009

(54) Systems and Methods for Authenticating and Authorizing a Message Receiver

(75) Inventor: Jesse Chou, Pleasanton, CA (US)

Correspondence Address: Venture Pacific Law, PC, 5201 Great America Parkway, Suite 270, Santa Clara, CA, 95054, US

(73) Assignee: HIGHER CHALLENGE, INC., Pleasanton, CA (US)

(21) Appl. No.: 12/372,728

(22) Filed: Feb. 17, 2009

Related U.S. Application Data
(60) Provisional application No. 61/028,865, filed on Feb. 14, 2008.

(51) Int. Cl. H04L 9/32; H04L 9/30

(52) U.S. Cl. 713/170; 380/285

(57) ABSTRACT

Systems and methods for authenticating a message receiver and for authorizing the authenticated receiver to manipulate the received message are disclosed. Various message delivery mechanisms and sender authentication mechanisms are used to perform receiver authentication. When a message (message A) is delivered to the receiver, the receiver cannot view or manipulate the message until the receiver is authenticated by the sender or by a sender-authorized third party. In this system, the receiver sends out a message (message B) to the sender to indicate the reception of the message A. Message B is then authenticated using a sender authentication mechanism. Once Message B is authenticated as coming from the intended receiver, the sender of message A authorizes the appropriate privilege for the receiver to manipulate message A.

### CROSS REFERENCE

This application claims priority from a provisional patent application entitled “Receiver ID—authentication and authorization of the message receiver” filed on Feb. 14, 2008 and having an Application No. 61/028,865. Said application is incorporated herein by reference.

### FIELD OF INVENTION

The invention relates to systems and methods for authenticating a receiver of an electronic message (e.g., email, text mail, instant message, etc.) and, more particularly to, systems and methods for verifying an electronic address of a receiver of an electronic message using sender authentication protocols.

### BACKGROUND

The use of electronic messaging systems (e.g., email systems, phone text messaging systems, computer instant messaging systems, and other electronic messaging systems) has proliferated across the world at an exponential rate. For instance, email has become an integral part of people's everyday business and personal lives. With the use of these electronic messaging systems, people can communicate across continents, states, cities, streets, and cubicles with friends, family, co-workers, and businesses.

However, as with other technological innovations, electronic communications systems are subject to abuse. For instance, email systems are hacked to gain private information. One of the most common commercial abuses of email is sending a mass number of emails to random email addresses. Email users are deluged with unsolicited junk email, also called “spam”. Even other electronic messaging systems, such as instant messaging systems, are subject to spam.

As a result, some email service providers, such as Yahoo, have responded to their users' complaints by allowing a user to specify email addresses and domain names in a junk emailer list. The email service provider can then determine whether each email message sent to the user is from a sender on the junk emailer list. Any such email is filtered and stored in the user's junk mailbox, while other emails are saved in the user's normal mailbox. However, spammers can alter the sender's address in the header of an email to circumvent anti-spam software from detecting spam emails.

As spam runs rampant, sender authentication protocols are gaining greater importance in detecting an altered sender's address in the header of an email. The following are the major sender authentication schemes for emails: (1) Sender Policy Framework (SPF); (2) Sender ID; and (3) Domain keys, described in U.S. Pat. Nos. 6,986,049 and 7,313,700.

With respect to SPF, owners of domain names can use a special format of domain name system (DNS) TXT records or SPF records to specify in the domain name system registry a list of Internet Protocol (IP) addresses that are authorized to handle email transmissions for their domains. For example, the owner of the example.org domain can designate which machines are authorized to send email from email addresses ending with “@example.org”. Receivers of an email can then check the SPF and reject messages from unauthorized addresses.

With respect to Sender ID, in addition to checking a message's “bounce” address, the domain name in the “from” header of each message is also verified. Recipients can reject messages that claim to be from “Someone Example.com” if those messages came from IP addresses that are not in the DNS registry list for Example.com.

With respect to Domain Keys, besides verification of a “bounce” address, the Domain Keys protocol can “sign” each outgoing message using a digital certificate to make sure that the message is not altered by anyone along the way.

However, these sender authentication protocols are only effective if the sender can be sure that the receiver is the intended audience. Unfortunately, sender authentication protocols do not prevent sent emails from reaching unintended audiences. For instance, sent emails can be intercepted along its path to the receiver; email may be delivered to the wrong receiver; or malicious attempts to gain access to a sent email may occur. The authentication problem is very prominent in the email environment since email is the most widely used communication tool and since email protocols were not originally designed to tackle the authentication problem.

Sender ID, Sender Policy Framework, and Domain Key are various augmentations to the email system that seek to authenticate the sender of an email. Authentication is accomplished by expanding an email's metadata, where the additional metadata can be appended by email service providers or mail transport agents (MTAs). However, there is still a problem for the sender to authenticate the receiver. The sender cannot verify whether the message was sent to the intended receiver, or whether the situation arises where it is no longer appropriate for the receiver to view or manipulate the message.

Therefore, it is desirable to provide methods for using message sender authentication protocols to help authenticate receivers of the message, and to combine receiver authentication protocols with encryption key services such that the transmitted message can be encrypted to prevent unintended audiences from viewing the contents of the electronic message.

### SUMMARY OF INVENTION

An object of this invention is to provide methods to use sender authentication protocols to authenticate receivers of an electronic message.

Another object of this invention is to provide methods to combine receiver authentication protocols with encryption key services, such that a transmitted electronic message can be encrypted to prevent unintended audiences from viewing the contents of the message.

Yet another object of this invention is to perform authentication of a receiver of an electronic message in real-time.

Briefly stated, the present invention is a method that utilizes sender authentication protocols to authenticate a receiver of an electronic message.

An advantage of this invention is that methods to use sender authentication protocols to authenticate receivers of an electronic message are provided.

Another advantage of this invention is that methods to combine receiver authentication protocols with encryption key services are provided such that a transmitted electronic message can be encrypted to prevent unintended audiences from viewing the contents of the message.

Yet another advantage of this invention is that methods to perform authentication of a receiver of an electronic message in real-time are provided.

### DESCRIPTION OF THE DRAWINGS

The foregoing and other objects, aspects, and advantages of the invention will be better understood from the following detailed description of the preferred embodiment of the invention when taken in conjunction with the accompanying drawings in which:

FIG. 1 illustrates a high level architecture for an embodiment of the present invention for a receiver ID system.

FIG. 2 illustrates a high level architecture for another embodiment of the present invention for a receiver ID system.

FIG. 3 illustrates a process flow for an embodiment of the present invention for a receiver ID system, wherein the receiver's address is verified.

FIG. 4 illustrates a process flow for another embodiment of the present invention for a receiver ID system, wherein the receiver's address has already been verified.

FIG. 5 illustrates a process flow for an embodiment of the present invention for a receiver ID system with a one-time receiver registration delay.

FIG. 6 illustrates a process flow for an embodiment of the present invention using an http/https channel to perform real-time message delivery of an electronic message to an authenticated receiver.

FIG. 7 illustrates a process flow for another embodiment of the present invention where receiver ID mail transport agents, registered in a DNS registry for the respective sender and receiver email domains, are used.

FIG. 8 illustrates a process flow for an embodiment of the present invention for a near real-time message delivery system using receiver ID, where the receiver undergoes a one-time pre-authentication step.

### DETAILED DESCRIPTION OF THE PREFERRED EMBODIMENTS

The detailed description of the invention will focus on an email system as an example of electronic messaging systems. However, it should be understood that the present invention can be applied to any and all types of electronic messaging systems, including SMS text messaging systems, instant messaging systems, and other messaging systems.

In an embodiment of the present invention for a receiver authentication system, herein referred to as receiver ID, receiver ID can be layered on top of sender authentication protocols (e.g., Sender ID) to authenticate the receiver of a message to the sender. In this way, an encrypted message can be decrypted knowing that the receiver is the intended receiver of the message. This can be implemented by a receiver sending a message to the sender of that message, and then receiving an authentication from the sender using Sender ID or other sender authentication protocols.

With respect to web based email, the same receiver ID can be applied to web based email systems. By the same token, receiver ID can be layered on top of all other messaging systems.

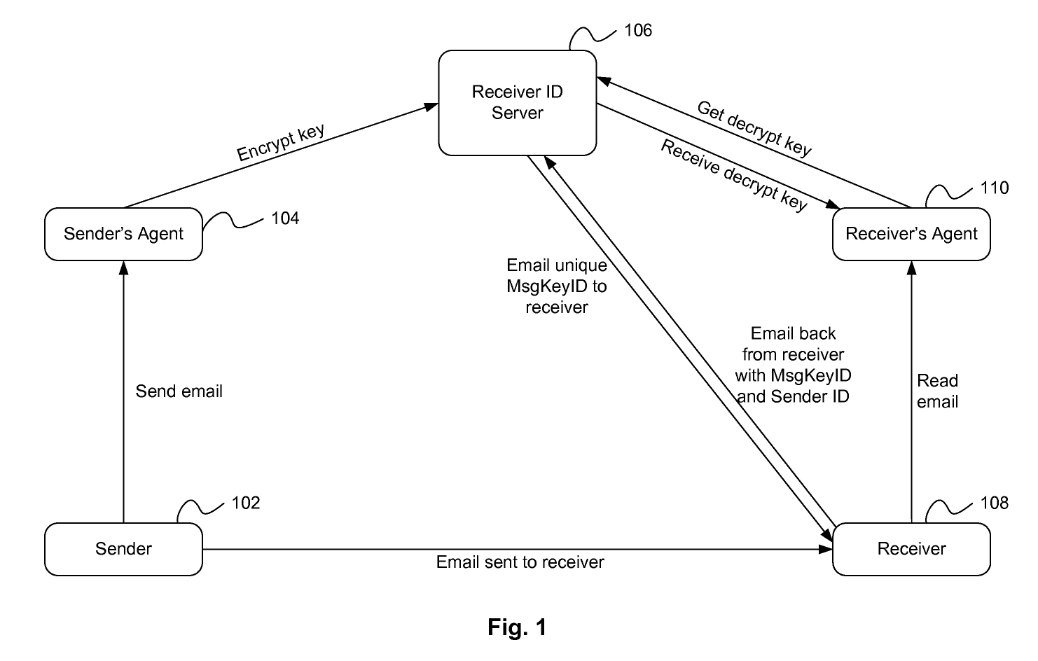

FIG. 1 illustrates a high level architecture of an embodiment of the present invention for a receiver ID system. In this embodiment of the present invention, the receiver ID system comprises of a sender 102, a receiver 108, a sender's agent 104, a receiver's agent 110, and a receiver ID server 106. The sender's agent 104 can be software running on the sender's 102 side. The receiver ID server 106 can be a third party key manager. Alternatively, a public key/private key third party agent can also be used as the receiver ID server 106.

When the sender 102 sends an email, the email is processed by the sender's agent 104. The sender's agent 104 encrypts the email with an encryption key and can assign the email a message ID, which is unique to that message. The encryption key and the message ID are sent to the server via a secured channel (e.g., HTTPS or SSL). The message ID, the sender's email address, the receiver's email address, and the encryption key are stored on the receiver ID server 106.

The encrypted email can then be sent from the sender's email client to the receiver email client via one or more public mail transport agents (MTAs); MTAs are not shown in FIG. 1. The receiver 108 receives the encrypted email, but is not able to read it since the body of the email has been encrypted. The receiver 108 sends a request to read the email to the receiver's agent 110. The receiver's agent 110 then fetches a key, also referred to as a decryption key, from the receiver ID server 106 to decrypt the email. The receiver's agent 110 connects to the receiver ID server 106 using a secure channel. The receiver's agent 110 can then email the message ID to the receiver ID server 106.

The receiver ID server 106 determines whether the message ID matches its records, where each record can have the following fields: (1) the email address of the sender; (2) the email address of the intended receiver; (3) the message ID for the message; and (4) the decryption key. If there is a matching record, the server will determine whether the receiver 108 is the intended receiver by matching the receiver's 108 address with the intended receiver's address in the record.

The receiver 108 can be authenticated by the receiver ID server 106 which first sends a message key ID to the receiver. (The message key ID can also be embedded in the mail body of the encrypted email sent from the sender 102). The receiver 108 sends back the message key ID along with the Sender ID (or by any other means of sender authentication) to verify the receiver 108 is the intended receiver. The receiver 108 via the receiver's agent 110 can send the message key ID and sender identification with respect to that receiver 108 for the receiver ID server 106 to authenticate the receiver 108. If the receiver 108 is authenticated (e.g. IP address of the receiver 108 matches that address stored on the DNS server), then the corresponding decryption key for the email is sent to the receiver 108. The DNS server translates human friendly computer hostnames into IP addresses, and can also store a list of mail servers that accept email for a given Internet domain.

If the receiver 108 is authenticated, then the encryption key is sent to the receiver's agent 110 to decrypt the email. In this example, the encryption key and the decryption key are the same. However, it would be appreciated by a person having ordinary skill in the art that other encryption schemes can be used to implement the encryption of a message for the present invention. For instance, in other encryption schemes the encryption key and the decryption key may be different, or a public/private key scheme may be implemented (e.g., RSA).

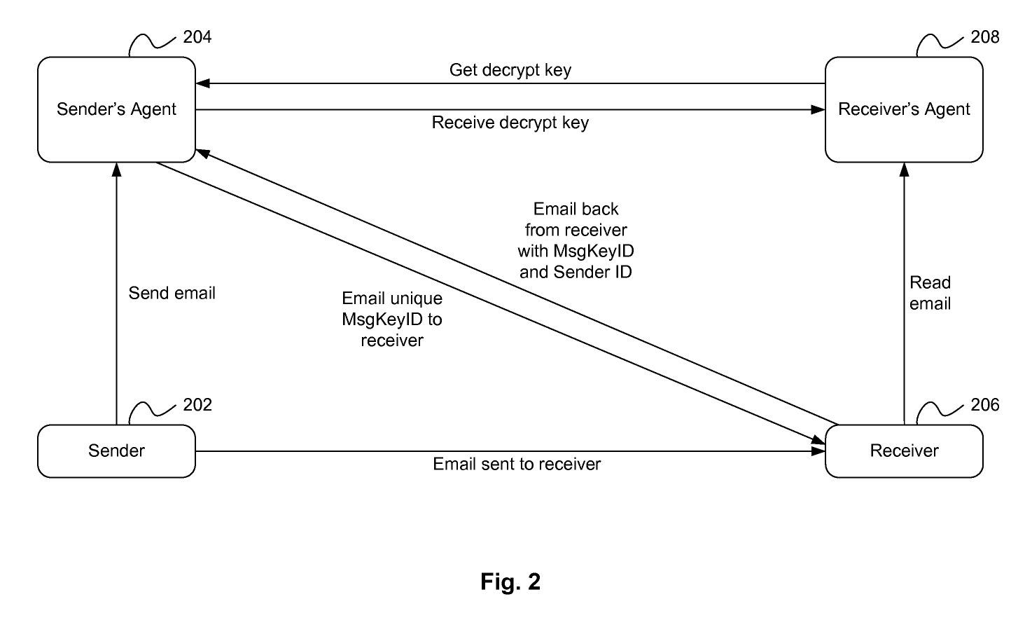

FIG. 2 illustrates a high level architecture for another embodiment of the present invention for a receiver ID system. In this embodiment, a receiver ID system comprises of a sender 202, a sender's agent 204, a receiver 206, and a receiver's agent 208. The functionality provided for by the receiver ID server in FIG. 1 can be replaced by the sender's agent 204 and the receiver's agent 208. Referring to FIG. 2, the sender's agent 204 can communicate directly with the receiver 206 via the receiver's agent 208. Additionally the sender's agent 204 can perform the authentication of the receiver 206.

When the sender 202 sends an email, that email is sent to the sender's agent 204. The sender's agent 204 encrypts the email using an encryption key and generates a unique message ID to identify that message. The encrypted message is sent to the receiver 206. The receiver 206 then requests the receiver's agent 208 to retrieve the decryption key from the sender's agent 204. The sender's agent 204 authenticates the receiver 206. In FIG. 1, the receiver ID server authenticates the receiver; whereas in FIG. 2, the authentication of the receiver 206 is handled by the sender's agent 204. Referring to FIG. 2, if the receiver 206 is successfully authenticated, then the sender's agent 204 can send the decryption key to the receiver's agent 208. The receiver's agent 208 decrypts the email for the receiver 206 to read and/or modify it.

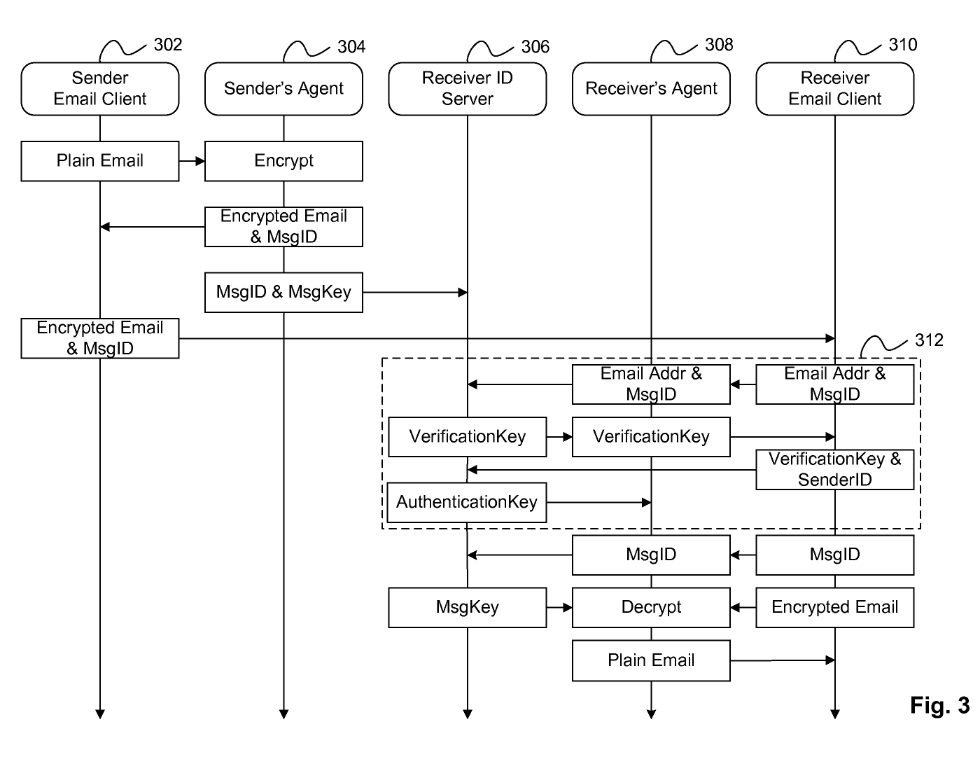

FIG. 3 illustrates a process flow for an embodiment of the present invention for a receiver ID system, wherein the receiver's email address is verified. The various entities in a receiver ID system are listed at the top of FIG. 3, including a sender email client 302, a sender's agent 304, a receiver ID server 306, a receiver's agent 308, and a receiver's email client 310. Here, the message encryption and decryption, as well as authentication of the receiver, can be performed once the receiver email client 310 has been verified 312.

The sender email client 302 first sends a plain email to the sender's agent 304 to encrypt it. The sender's agent 304 encrypts the message and attaches a message ID to the encrypted email, then sends it back to the sender email client 302. The sender's agent 304 sends the message ID and the encryption key used to encrypt the message to the receiver ID server 306. Shortly after encryption of the email, the encrypted email with the message ID embedded in the encrypted email is sent to the receiver email client 310.

The receiver email client 310 sends its email address and the message ID via the receiver's agent 308 to the receiver ID server 306 to be authenticated. The receiver ID server 306 uses sender authentication protocols to verify whether the receiver 310 is the owner of the email address that was sent with the email.

The receiver ID server 306 sends a verification key via the receiver's agent 308 to the receiver email client 310. The receiver email client 310 emails that verification key along with its sender ID to the receiver ID server 306. If the verification key is identical to the one that the receiver ID server 306 sent to the receiver email client 330 and the receiver's email address is authenticated by the sender ID, then the receiver ID server 306 sends an authentication key to the receiver's agent 308 to be stored on the receiver email client 310 side. For future authentications, the receiver can simply send the unique authentication key to authenticate itself to the receiver ID server 306.

The purpose of the verification process 312 is to verify that the receiver email client is a user of the email address from which the receiver email client 310 states is his/her address. This can be viewed as a form of registration. Generally, when a user subscribes to an online service with an email address, the service will verify the email address by sending an email to that email address requesting that the user of the email address click on a link within that email to verify that the subscriber of the service is the same person as the user of the email address. Once verification is complete, there is no need to repeat these steps for future verifications. Similarly, the receiver email client 310 may only need to verify ownership of its email address once.

Once registered, the authentication key can be used for future authentications, instead of having to go through the process of reverifying the receiver email client 312. Up to this point, the receiver's agent 308 can be an optional component in this system since verification can happen directly between the receiver ID server 306 and the email client 310. Therefore, it would be appreciated by a person having ordinary skill in the art that verification can be accomplished in other ways and with a variety of other components that perform equivalent functions as described in FIG. 3.

The authentication key can be stored on the receiver email client's 310 side. When another email arrives in the inbox of the receiver, the receiver's agent 308 can look up the authentication key on the receiver's local storage. The receiver's agent 308 then can send the authentication key to the receiver ID server 306 using the authentication key. The message ID is then sent to the server 306 so that the server 306 can look up the corresponding message key to decrypt the encrypted email. The message key is sent back to the receiver's agent 308. The receiver's agent 308 can then decrypt the message. Once decrypted, the unencrypted email can be sent back to the receiver email client 310.

Since the sender's agent and the receiver's agent play a central role in the receiver ID system, it is important to have security safeguards to prevent tampering of these agents. One of these safeguards is to have a unique serial ID number corresponding to the email address. When the email address is used, this unique serial ID number can be sent along with that email address to assure that the agent corresponds to the email address. Also a checksum algorithm can be used to prevent hackers from altering the code of an agent.

Receiver ID can be performed in almost near real time since authentication can be simply performed by sending the unique authentication key from the receiver's agent.

Note, the message ID is unique to each message. The receiver ID server can generate a message ID for each email. The message ID can also be coupled with the sender's email address and the receiver's email address to form a unique pairing. For instance, if a message ID is “1234”, then “1234” can be followed by the sender's address and the receiver's address to form a unique combination. This can be advantageous when there are multiple recipients to whom an email is sent.

For instance, if an email with an message ID, “1234”, is sent to John's address, “555”, and to Tim's address, “666”, then each recipient can have different records on the receiver ID server since the pairing of the message ID and John's address (i.e. “1234555”) is different from the pairing of the message ID and Tim's address (i.e. “1234666”). If only one receiver is authenticated, only the authenticated receiver with be sent the decryption key; whereas, if the two records were jointly combined into one record, then both the receivers could possibly be sent the decryption key.

In yet another embodiment of the present invention, pregenerated message key IDs for a sender can be prefetched by the receiver's agent and stored on the receiver's computer. Additionally, the verification can be replaced by a public key and private key scheme (e.g., PGP) so that the use of a receiver ID server can be entirely eliminated.

The functionality of the receiver ID server can be replaced by the receiver's agent and the sender's agent. For instance, the verification key step and the authentication step can be performed by an agent. Thus, one layer of complication can be simplified. Also, a checksum algorithm and a built-in unique serial number to identify an agent can be employed to guarantee the agent is not hacked.

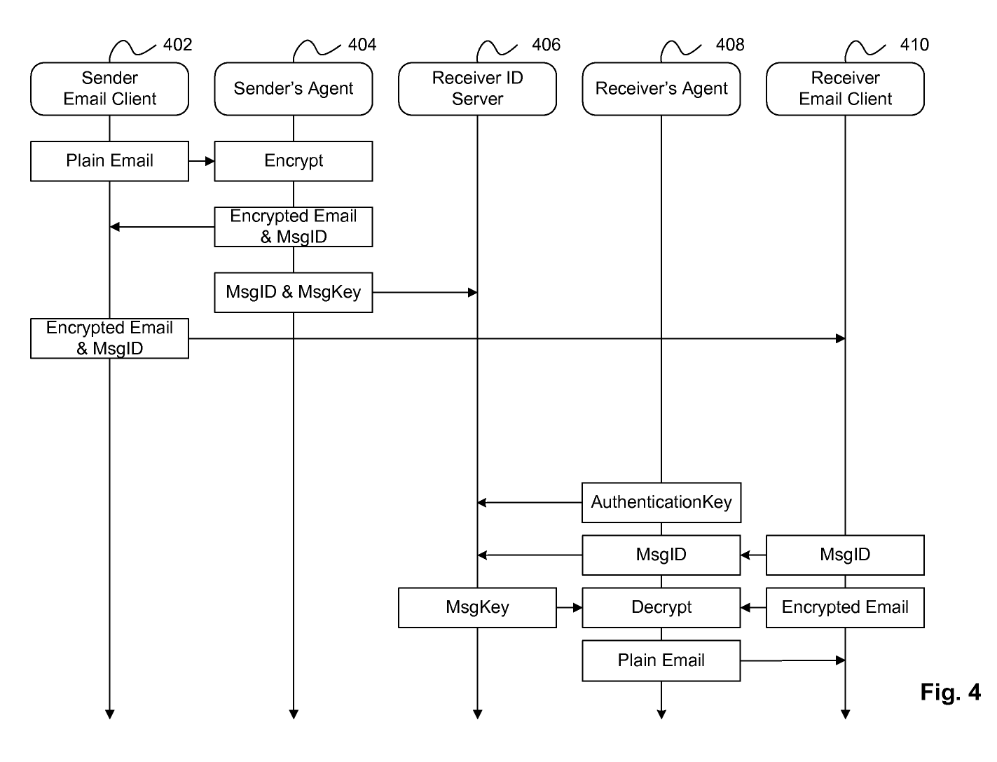

FIG. 4 illustrates a process flow for an embodiment of the present invention for a receiver ID system, where a receiver email client 410 has already been verified. Since the receiver email client 410 has been verified, the authentication key is saved onto the receiver email client's memory. When the receiver email client 410 is authenticated, the receiver email client 410 can simply send the authentication key to the receiver ID server for authentication. The other steps in FIG. 4 mirror the corresponding steps in FIG. 3.

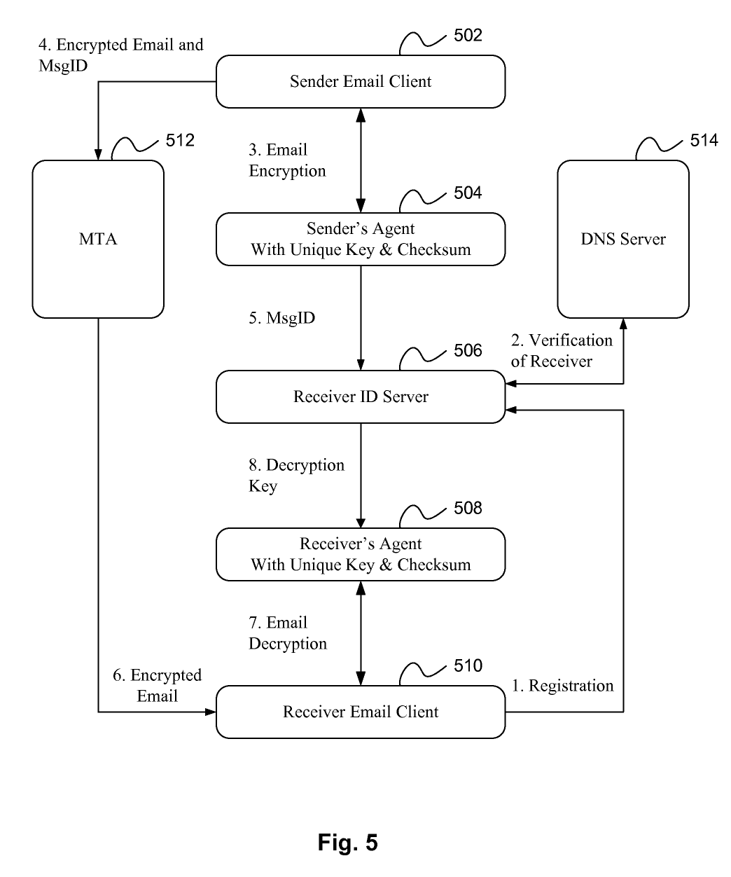

FIG. 5 illustrates a process flow for an embodiment of the present invention for receiver authentication with a receiver registration delay. First, a receiver email client 510 registers with a receiver ID server 506. The receiver ID server 506 utilizes a sender ID authentication by verifying the receiver's address with a list of addresses for the receiver's domain name on a DNS server 514.

If verification is successful, a sender email client 502 can send an email to the receiver email client 510. The sender email client 502 first sends a plain email to the sender's agent 504. The sender's agent 504 can have a unique key and a checksum to determine whether the sender's agent 504 has been tampered. The sender's agent 504 encrypts the email and generates a unique message ID for that email. The encrypted email can then be sent to the receiver email client 510 via a MTA 512; and the message ID is sent to a receiver ID server 506.

The receiver email client 510 can then request the receiver's agent 508 to decrypt the email by getting the decryption key from the receiver ID server 506. The receiver's agent 508 can verify itself to the receiver ID server 506 by sending its unique key and checksum to the receiver ID server 506. If verification is successful, the decryption key is sent to the receiver's agent 508 to decrypt the email. The decrypted email is then passed to the receiver email client 510.

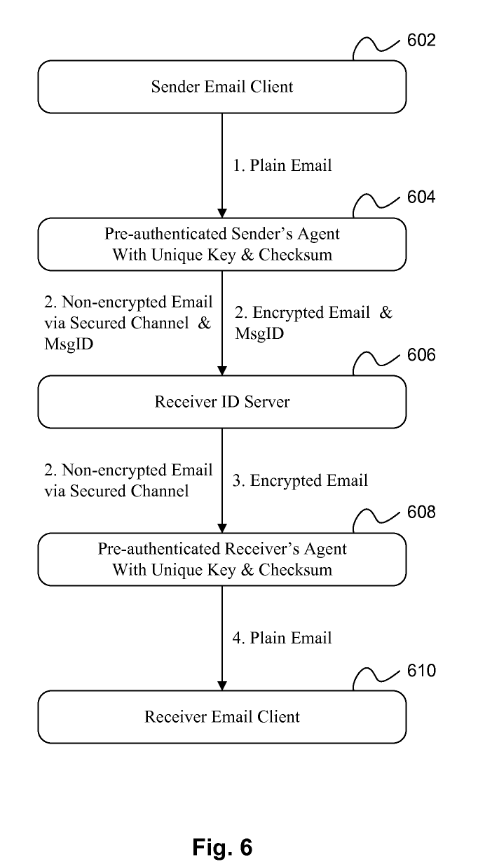

FIG. 6 illustrates a process flow of an embodiment of the present invention using a http/https channel to perform real-time message delivery of an electronic message to an authenticated receiver. Encryption of the message during transit and authentication of the receiver of the message can be performed such that confidentiality protection is effective since the sender is assured that the receiver is the intended receiver. To make the decryption run in real-time, an embodiment of the invention can combine real-time email methods (e.g. SMTP through HTTP, or push-mail) for an email to be sent back from the receiver to the sender to authenticate the receiver using sender authentication methods.

A sender email client 602 can send an email to a pre-authenticated sender's agent 604. The sender's agent 604 can send the non-encrypted email via a secured channel and message ID or can send an encrypted email with a message ID to a receiver ID server 606. Since the sender's agent 604 is pre-authenticated, the sender's agent 604 can send its unique key and checksum to the receiver ID server 605 to authenticate the sender's agent 604.

If an encrypted email was sent to the receiver ID server, the receiver ID server 606 can send that encrypted email to a receiver email client 610 via a pre-authenticated receiver's agent 608. Decryption can be performed in the same manner as previously stated. Alternatively, if the plain email (e.g., non-encrypted email) is sent to the receiver ID sever 606 through a secured channel, then that email is delivered to the receiver email client 610 via the receiver's agent 608 through a secured channel.

A third party key management trustee can also be involved. The receiver authentication can also be done using a client-side software with a unique key and a verification checksum. After the receiver is pre-authenticated through the ordinary sender authentication methods, the client-side software can combine real-time authentication to fetch a decryption key through a secured channel (e.g. SSL).

In order for a receiver ID system to work in real-time, a real-time message key service is needed such that the encryption and decryption keys can be confidentially exchanged when the receiver is obtaining proper authentication and receiving proper authorization. One incarnation of this real time system can be to use established public/private key schemes (e.g., RSA) for the underlying mechanism.

With this service, any application can use the receiver ID system to perform authentication on the sender's side (or some other authentication key service) and to obtain the proper authorization (e.g., a decryption key). In other words, any intermediate email server may not have to be used to get the receiver's sender ID; instead, only one real-time key service can be used.

This real-time relaying service can be implemented by embedding SMTP over HTTP using Apache and Sendmail. A HTTP connection can be made on port 25 (i.e., email). Next, a POST command can be issued to a Sendmail server with SMTP content embedded in the posted data. The Sendmail server can then ignore the HTTP header, and accept the rest of the data. The Apache mod_proxy can also be modified to recognize such session, such that mod_proxy can invoke the authentication according to the prescription from the sender for a specific message ID and a specific receiver. Note, both Sendmail and mod_proxy are not necessary, but are convenient to use in this example.

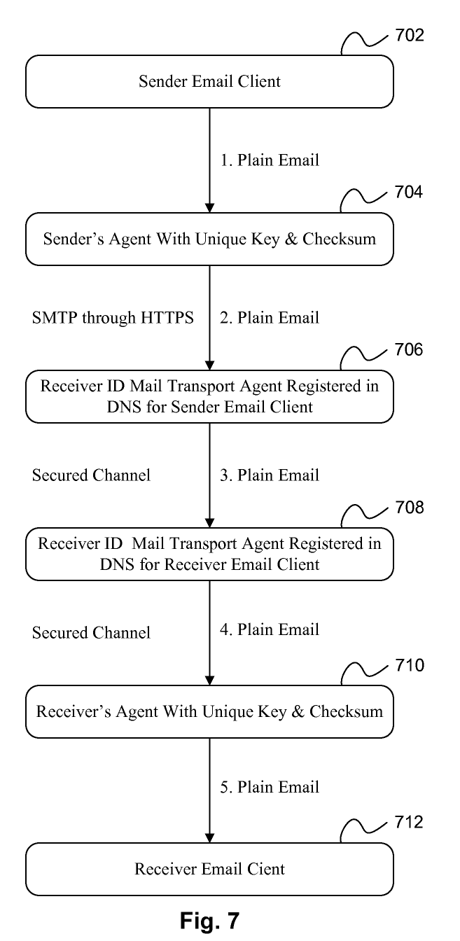

FIG. 7 illustrates a process flow for another embodiment of the present invention where receiver ID mail transport agents registered in a DNS registry for both sender and receiver email domains are used. The sender email client 702 sends an email via the sender's agent 704. The email can be submitted using SMTP through HTTPS to the receiver ID mail transport agent 706 for the sender and then forwarded to the receiver ID mail transport agent 708 for the receiver. Since the receiver ID mail transport agent 706 knows about other receiver ID mail transport agents, the email is forwarded to the receiver ID mail transport agent 708 who is registered for the receiver email domain in the DNS registry, and in turn forwards the email to the receiver email client 712 via the receiver's agent 710.

The advantages of this system are that the email is secured from unintended audiences since the paths taken are secured via a secured channel using SMTP through HTTPS (or other secured channels). Additionally, there is no time delay for decrypting the mail since the email is not encrypted.

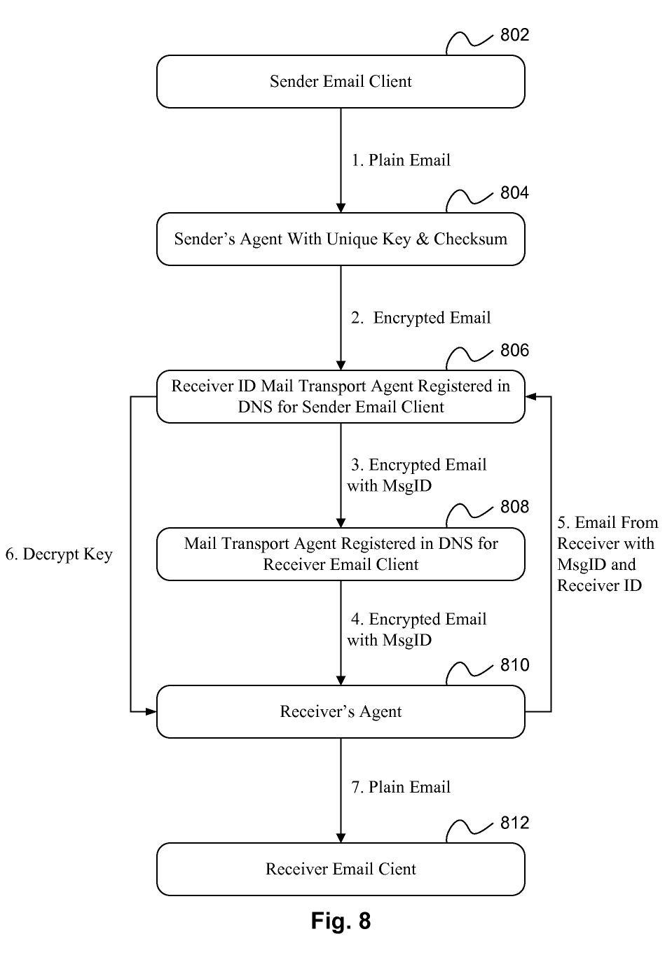

FIG. 8 illustrates a process flow for an embodiment of the present invention for a near real-time message delivery system using receiver ID, where the receiver undergoes a one time pre-authentication step. A sender email client 802 sends a plain email to the sender's agent 804. The agent encrypts the plain email and sends an encrypted email to a receiver ID MTA 806, which is registered in the DNS for the sender email client 802. The receiver ID MTA 806 sends the encrypted email with a message ID for that email to a MTA 808 registered in the DNS for the receiver email client 802.

The receiver's agent 810 receives the encrypted email with the message ID from the MTA 808. The receiver's agent 810 sends the message ID and the receiver ID to the receiver ID MTA 806 to authenticate the receiver email client 812. If the receiver email client passes the authentication, the receiver ID MTA 808 looks up the associated decryption key for that particular message ID and receiver ID, and then sends the decryption key to the receiver's agent 810. The receiver's agent 810 can use the decryption key to decrypt the email and relay the plain email to the receiver email client 812.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We claim:

1. A method for authenticating a receiver of an electronic message, wherein said receiver having a sender ID, comprising the steps of:
encrypting the message using a message key;
generating a message identifier for the encrypted message;
sending the encrypted message and the message identifier to the receiver;
authenticating the receiver as a function of the message identifier and the sender ID of the receiver; and
if the receiver is successfully authenticated, sending the message key to the receiver to decrypt the message.

2. The method of claim 1 wherein before the authenticating step, further comprising the step of: verifying the sender ID of the receiver.

3. The method of claim 1 wherein in the authenticating step, one of the following authenticating protocols is used to authenticate the receiver: SPF, Sender ID, and Domain Key.

4. The method of claim 1 wherein the message key is generated by a public/private key scheme.

5. The method of claim 1 wherein the receiver has an electronic address and the sender ID is the electronic address of the receiver.

6. The method of claim 1 wherein in the authenticating the receiver step, the receiver uses an authentication key and a checksum for subsequent authentications.

7. The method of claim 1 wherein in the sending step, the message is submitted using SMTP through HTTPS.

8. The method of claim 2 wherein the verifying step is performed by a receiver ID server.

9. The method of claim 1 wherein the authenticating step is performed by a receiver ID server.

10. The method of claim 1 wherein the sender ID is authenticated using a DNS protocol.

11. A method for authenticating a receiver of an electronic message, wherein said receiver having a sender ID, comprising the steps of:
encrypting the message using a message key;
generating a message identifier for the encrypted message;
sending the encrypted message and the message identifier to the receiver;
verifying the sender ID of the receiver;
authenticating the receiver as a function of the message identifier and the sender ID of the receiver; and
if the receiver is successfully authenticated, sending the message key to the receiver to decrypt the message.

12. The method of claim 11 wherein in the authenticating step, one of the following authenticating protocols is used to authenticate the receiver: SPF, Sender ID, and Domain Key.

13. The method of claim 11 wherein the message key is generated by a public/private key scheme.

14. The method of claim 11 wherein the receiver has an electronic address and the sender ID is the electronic address of the receiver.

15. The method of claim 11 wherein in the authenticating the receiver step, the receiver uses an authentication key and a checksum for subsequent authentications.

16. The method of claim 11 wherein in the sending step, the message is submitted using SMTP through HTTPS.

17. The method of claim 12 wherein the verifying step is performed by a receiver ID server.

18. The method of claim 11 wherein the authenticating step is performed by a receiver ID server.

19. The method of claim 11 wherein the sender ID is authenticated using a DNS protocol.

20. A method for authenticating a receiver of an electronic message, wherein said receiver having an electronic address, comprising the steps of:
verifying the electronic address of the receiver by a receiver ID server;
encrypting the message using a message key, wherein the message key is generated by a public/private key scheme;
generating a message identifier for the encrypted message;
sending the encrypted message and the message identifier to the receiver;
authenticating the receiver by a receiver ID server as a function of the message identifier and the electronic address of the receiver, wherein the electronic address is authenticated using a DNS protocol; and
if the receiver is successfully authenticated, sending the message key to the receiver to decrypt the message.
